(19) United States
(12) Patent Application Publication
(10) Pub. No.: US 2020/0095437 A1
(43) Pub. Date: Mar. 26, 2020

(54) ACTIVE-ENERGY-RAY-CURABLE COMPOSITION, ACTIVE-ENERGY-RAY-CURABLE COMPOSITION PRIMER, CURED PRODUCT, STORED CONTAINER, TWO-DIMENSIONAL OR THREE-DIMENSIONAL IMAGE FORMING APPARATUS, AND TWO-DIMENSIONAL OR THREE-DIMENSIONAL IMAGE FORMING METHOD

(71) Applicants: Yuri HAGA, Tokyo (JP); Mio KUMAI, Tokyo (JP); Hidefumi NAGASHIMA, Kanagawa (JP); Maiko KOEDA, Shizuoka (JP)

(72) Inventors: Yuri HAGA, Tokyo (JP); Mio KUMAI, Tokyo (JP); Hidefumi NAGASHIMA, Kanagawa (JP); Maiko KOEDA, Shizuoka (JP)

(21) Appl. No.: 16/471,356

(22) PCT Filed: Dec. 20, 2017
(86) PCT No.: PCT/JP2017/045838

§ 371 Date: Jun. 19, 2019

(30) Foreign Application Priority Data
Dec. 21, 2016 (JP) 2016-248033
Nov. 15, 2017 (JP) 2017-220277

(51) Int. Cl. C09D 11/101; C09D 11/107; C09D 11/30; B33Y 70/00

(52) U.S. Cl. CPC C09D 11/101; C09D 11/107; B29C 64/112; B33Y 70/00; C09D 11/30

(57) ABSTRACT

To provide an active-energy-ray-curable composition including a resin, where a ratio S₃/S₃₀ of the active-energy-ray-curable composition is 0.3 or more but 0.6 or less in a ¹H-NMR spectrum of the active-energy-ray-curable composition, the ¹H-NMR spectrum is obtained when a concentration of the active-energy-ray-curable composition in deuterated chloroform as a solvent is 3% by mass, the S₃₀ is an integrated value of all signals in the ¹H-NMR spectrum, and the S₃ is an integrated value of at least one broad signal in the ¹H-NMR spectrum.

### TECHNICAL FIELD

The present disclosure relates to an active-energy-ray-curable composition, an active-energy-ray-curable composition primer, a cured product, a stored container, a two-dimensional or three-dimensional image forming apparatus, and a two-dimensional or three-dimensional image forming method.

### BACKGROUND ART

In recent years, there is a need for an active-energy-ray-curable ink composition, which can be fixed on various recording media such as impermeable substrates and building materials and can be recorded.

A structure included in a polymerizable monomer is determined and an energy-ray-curable inkjet ink composition excellent in close adhesiveness and drawability has been proposed (see, for example, PTL 1).

In addition, an inkjet recording method achieving excellent blocking resistance and close adhesiveness has been proposed when an ultraviolet-ray-curable ink composition is ejected to a primer layer including a specific ultraviolet absorber on the surface of the recording medium to be printed (see, for example, PTL 2).

### CITATION LIST

### Patent Literature

### PTL 1: Japanese Unexamined Patent Application Publication No. 2013-142104

### PTL 2: Japanese Patent No. 5758953

### SUMMARY OF INVENTION

### Technical Problem

The present disclosure has an object to provide an active-energy-ray-curable composition that can form a cured product excellent in blocking resistance, close adhesiveness, and drawability.

### Solution to Problem

Means for solving the aforementioned problems, an active-energy-ray-curable composition of the present disclosure includes a resin, where a ratio (S₃/S₃₀) of the active-energy-ray-curable composition is 0.3 or more but 0.6 or less in a ¹H-NMR spectrum of the active-energy-ray-curable composition, the ¹H-NMR spectrum is obtained when a concentration of the active-energy-ray-curable composition in deuterated chloroform as a solvent is 3% by mass, the S₃₀ is an integrated value of all signals in the ¹H-NMR spectrum, and the S₃ is an integrated value of at least one broad signal in the ¹H-NMR spectrum.

### Advantageous Effects of Invention

According to the present disclosure, it is possible to provide an active-energy-ray-curable composition that can form a cured product excellent in blocking resistance, close adhesiveness, and drawability.

### BRIEF DESCRIPTION OF DRAWINGS

FIG. 1 is a schematic view of an example of an image forming apparatus of the present disclosure.

FIG. 2 is a schematic view of an example of another image forming apparatus of the present disclosure.

FIG. 3A is a schematic view of an example of still another image forming apparatus of the present disclosure.

FIG. 3B is a schematic view of an example of still another image forming apparatus of the present disclosure.

FIG. 3C is a schematic view of an example of still another image forming apparatus of the present disclosure.

FIG. 3D is a schematic view of an example of still another image forming apparatus of the present disclosure.

FIG. 4 presents a broad signal not overlapped with the adjacent signal.

FIG. 5 presents a broad signal overlapped with at least part of the adjacent signal thereto.

FIG. 6 presents a broad signal made of overlapped adjacent signals and having a deformed wave profile.

### DESCRIPTION OF EMBODIMENTS

(Active-Energy-Ray-Curable Composition)

An active-energy-ray-curable composition of the present disclosure includes a resin, where a ratio (S₃/S₃₀) of the active-energy-ray-curable composition is 0.3 or more but 0.6 or less in a ¹H-NMR spectrum of the active-energy-ray-curable composition, the ¹H-NMR spectrum is obtained when a concentration of the active-energy-ray-curable composition in deuterated chloroform as a solvent is 3% by mass, the S₃₀ is an integrated value of all signals in the ¹H-NMR spectrum, and the S₃ is an integrated value of at least one broad signal in the ¹H-NMR spectrum. The active-energy-ray-curable composition preferably includes an active-energy-ray-curable compound, a cross-linking agent, a polymerization initiator, a polymerization inhibitor, and an organic solvent, and further includes other components such as a pigment if necessary.

The active-energy-ray-curable composition of the present disclosure is based on the finding that the existing active-energy-ray-curable compositions, the existing energy-ray-curable inkjet ink compositions, and the existing inkjet recording methods cannot satisfy effects of the blocking resistance, close adhesiveness, and drawability at the same time, which is problematic.

A ratio (S₃/S₃₀) of the active-energy-ray-curable composition is 0.3 or more but 0.6 or less, preferably 0.3 or more but 0.45 or less in a ¹H-NMR spectrum of the active-energy-ray-curable composition obtained when a concentration of the active-energy-ray-curable composition in deuterated chloroform as a solvent is 3% by mass.

When the ratio (S₃/S₃₀) is 0.3 or more, the resin hardly moves in the active-energy-ray-curable composition. As a result, viscosity of the active-energy-ray-curable composition can increase to improve blocking resistance and close adhesiveness. When the ratio (S₃/S₃₀) is 0.6 or less, the resin in the active-energy-ray-curable composition easily moves. As a result, viscosity of the active-energy-ray-curable composition can be lowered to improve drawability.

In the ¹H-NMR spectrum of the active-energy-ray-curable composition obtained when a concentration of the active-energy-ray-curable composition is 3% by mass, the S₃ is an integrated value of at least one broad signal in the ¹H-NMR spectrum. In addition, the S₃₀ is an integrated value of all signals in the ¹H-NMR spectrum. Therefore, the ratio (S₃/S₃₀) is a ratio of the at least one broad signal to the all signals.

Here, the reason for the signal in the ¹H-NMR spectrum being broad is because an increased viscosity of the active-energy-ray-curable composition and a shortened relaxation time decrease resolution of the ¹H-NMR spectrum due to a concentration of the active-energy-ray-curable composition, a molecular weight of the resin, and a structure of the resin.

In the present disclosure, because the ratio (S₃/S₃₀) of the active-energy-ray-curable composition is 0.3 or more but 0.6 or less and a state of the active-energy-ray-curable compound and a state of the resin in the active-energy-ray-curable composition can be controlled, it is possible to obtain a cured product satisfying effects of the blocking resistance, close adhesiveness, and drawability at the same time.

In the present disclosure, the broad signal means a signal satisfying the following conditions.

FIG. 4 presents a broad signal not overlapped with the adjacent signal. As presented in FIG. 4, regarding a signal not overlapped with the adjacent signal, in a signal in the ¹H-NMR spectrum, a point at which intensity of the signal is the highest is referred to as a peak P and a point at which a difference of the chemical shift between the point and the peak P is the smallest and intensity of the signal is the lowest is referred to as a bottom. Next, regarding the signal, a baseline L, a straight line M connecting the peak P and the bottom B_{H} at a side of the high magnetic field, and a straight line N connecting the peak P and the bottom B_{L} at a side of the low magnetic field are drawn. Then, an intersection point of the L and the M is referred to as “a” and an intersection point of the L and the N is referred to as “b”. The broad signal means a signal having a difference δ_{b}−δₐ of 0.1 ppm or more, where the difference δ_{b}−δₐ is determined by subtracting a chemical shift δₐ in the a from a chemical shift δ_{b} in the b.

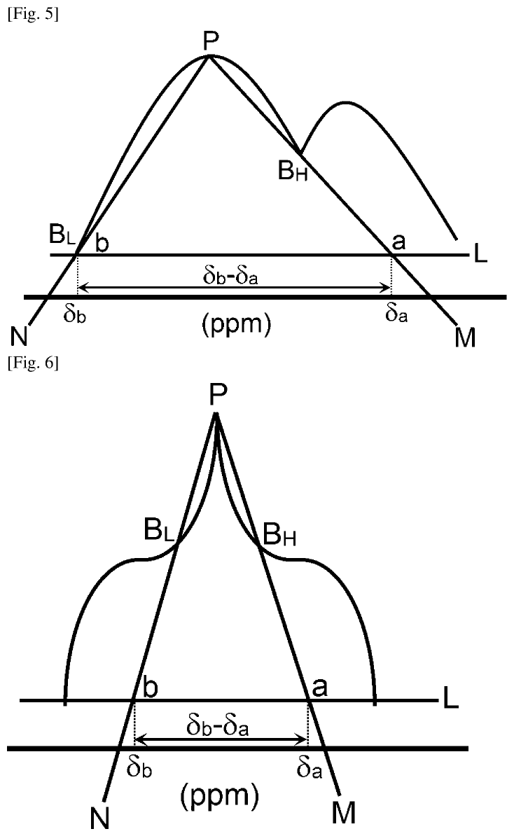

FIG. 5 presents a broad signal overlapped with at least part of the adjacent signal thereto. As presented in FIG. 5, the signal overlapped with at least part of the adjacent signal thereto is considered to be the same as a signal not overlapped with the adjacent signal, except that a point overlapped with the adjacent signal is referred to as B_{H} and/or B_{L} at the side where the signal is overlapped with the adjacent signal.

FIG. 6 presents a broad signal made of overlapped adjacent signals and having a deformed wave profile. As presented in FIG. 6, the signal made of overlapped adjacent signals and having a deformed wave profile is considered to be the same as a signal not overlapped with the adjacent signal, except that a point at which a difference of chemical shift between the peak P and the point is the smallest and the intensity of the signal is the lowest is referred to as B_{H} and B_{L} among parts having a deformed wave profile.

The base line can be obtained from a commercially available analysis software. As the commercially available analysis software, for example, Delta v5. 0.5 (available from JEOL Ltd.) can be used.

The S₃ and the S₃₀ can be obtained from the commercially available analysis software.

In the ¹H-NMR spectrum, an intensity of the signal represents a detection sensitivity. Therefore, it is considered that the signal having strong intensity and high detection sensitivity means a high concentration of the active-energy-ray-curable composition and a large amount of the active-energy-ray-curable compound included in a measurement sample.

<G Value>

According to the active-energy-ray-curable composition of the present disclosure, a G value of the active-energy-ray-curable composition is preferably 0.1 or more but 0.5 or less in a ¹H-NMR spectrum of the active-energy-ray-curable composition, more preferably 0.2 or more but 0.4 or less in the ¹H-NMR spectrum, where the G value is obtained by Formula (1) below:

G value=S₃/(S₃₀+S₁₀)−S₁/(S₃₀+S₁₀) Formula (1),

the ¹H-NMR spectrum is obtained when the concentration of the active-energy-ray-curable composition is 1% by mass, the S₁₀ is an integrated value of all signals in the ¹H-NMR spectrum, and the S₁ is an integrated value of at least one broad signal in the ¹H-NMR spectrum.

The G value of 0.1 or more allows the resin to easily move when a concentration of the active-energy-ray-curable composition is reduced, resulting in excellence in blocking resistance and close adhesiveness. When the G value is 0.5 or less, the movement of the resin can be steadily maintained to result in excellent drawability even when the concentration of the active-energy-ray-curable composition is reduced.

This reason for this is considered as described below. Specifically, in the ¹H-NMR spectrum of the active-energy-ray-curable composition, intensity of the signal presents detention sensitivity. The signal presenting high intensity and high detection sensitivity indicates high concentration of the active-energy-ray-curable composition and a large amount of the active-energy-ray-curable compound included in the measurement sample.

In the measurement of the ¹H-NMR spectrum, when the concentration of the active-energy-ray-curable composition is decreased, the resin in the active-energy-ray-curable composition easily moves. Therefore, when viscosity of the active-energy-ray-curable composition decreases and the relaxation time is long, resolution of the ¹H-NMR spectrum increases and the number of the broad signal is reduced.

When the concentration of the active-energy-ray-curable composition is reduced, the resin in the active-energy-ray-curable composition easily moves and causes a large change in viscosity of the active-energy-ray-curable composition. Therefore, the change in the concentration easily makes the broad signal sharp. Meanwhile, even when the concentration of the active-energy-ray-curable composition is decreased, the mobility of the resin does not change much and the change in the viscosity of the active-energy-ray-curable composition is small. Therefore, even when the concentration is changed, the signal hardly changes.

<Resin>

The resin is not particularly limited and may be appropriately selected depending on the intended purpose, so long as the resin is a compound including one or more polymerizable, ethylenically-unsaturated group. Examples of the resin include aromatic urethane oligomers, aliphatic urethane oligomers, epoxy acrylate oligomers, polyester acrylate oligomers, and other special oligomers. These may be used alone or in combination.

As the resin, a commercially available product can be used. Examples of the commercially available product include: UV-2000B, UV-2750B, UV-3000B, UV-3010B, UV-3200B, UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 (available from The Nippon Synthetic Chemical Industry Co., Ltd.); CN902, CN902J75, CN929, CN940, CN944, CN944B85, CN959, CN961E75, CN961H81, CN962, CN963, CN963A80, CN963B80, CN963E75, CN963E80, CN963J85, CN964, CN965, CN965A80, CN966, CN966A80, CN966B85, CN966H90, CN966J75, CN968, CN969, CN970, CN970A60, CN970E60, CN971, CN971A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 (available from Sartomer); and EBECRYL210, EBECRYL220, EBECRYL230, EBECRYL270, KRM8200, EBECRYL5129, EBECRYL8210, EBECRYL8301, EBECRYL8804, EBECRYL8807, EBECRYL9260, KRM7735, KRM8296, KRM8452, EBECRYL4858, EBECRYL8402, EBECRYL9270, EBECRYL8311, and EBECRYL8701 (available from DAICEL-ALLNEX LTD.). These may be used alone or in combination.

In addition to the commercially available product, a synthesized product obtained through synthesis can be used. Therefore, the synthesized product and the commercially available product can be used in combination.

The resin is preferably two or more kinds of resins. When the resin is two or more kinds of resins, the resins different in mobility exist in the active-energy-ray-curable composition. Therefore, it is possible to provide the active-energy-ray-curable composition excellent in blocking resistance, close adhesiveness, and drawability.

The active-energy-ray-curable composition of the present disclosure preferably includes the resin having a weight average molecular weight of 1×10³ or more but 1×10⁴ or less and the resin having a weight average molecular weight of more than 1×10⁴ but 1×10⁶ or less. This makes it possible to provide the active-energy-ray-curable composition, which can form a cured product excellent in blocking resistance, close adhesiveness, and drawability, because the resins different in mobility exist in the active-energy-ray-curable composition.

A weight average molecular weight of the resin can be measured by the gel permeation chromatography (GPC) in the same manner as in the measurement of the amount of the resin.

When the active-energy-ray-curable composition includes two or more kinds of resins, at least one of the two or more kinds of resins preferably includes a benzene structure unit. An amount of the resin having the benzene structure unit is preferably 25% by mass or more but 75% by mass or less relative to a total amount of the resins. This makes it possible to provide the active-energy-ray-curable composition, which can form a cured product excellent in blocking resistance, close adhesiveness, and drawability, because the resins different in mobility exist in the active-energy-ray-curable composition.

A ratio between the two or more kinds of resins can be measured by, for example, the liquid chromatography mass spectrometry (LC/MS), the infrared spectroscopy (IR), the thermogravimetry⋅differential thermal analysis (TG/DTA), the differential scanning calorimetry (DSC), or the gel permeation chromatography (GPC).

Whether the resin includes the benzene structure unit can be judged by the gas chromatography mass spectrometry (GC/MS). Specifically, the active-energy-ray-curable composition is 100-fold diluted with tetrahydrofuran and is subjected to centrifugal separation. The supernatant solution (2 microliters) obtained after the centrifugal separation can be used to judge whether the benzene structure unit is incorporated into the resin by confirming a signal derived from the benzene structure under the following measurement conditions.

—Measurement Devices and Measurement Conditions—
Gas chromatography analysis device: 7890B GC, available from Agilent Technologies Japan, Ltd.
Mass spectrometer: JMS-Q1500GC, available from JEOL Ltd.
Thermal analyzer: EGA/PY-3030D, available from Frontier Laboratories Ltd.
Thermal deposition temperature: 600 degrees Celsius
Temperature of the interface of the thermal analyzer: 280 degrees Celsius
Column: Ultra ALLOY⁺-5, available from Frontier Laboratories Ltd., length: 30.0 m, inner diameter: 0.25 mm, average film thickness: 0.25 micro meters
Column inlet temperature:280 degrees Celsius
Condition for heating column: 50 degrees Celsius (retained for 2 minutes), temperature elevation (20 degrees Celsius/min), and 280 degrees Celsius (retained for 11.5 minutes)
Pressure of carrier gas: 49.38 kPa (constant)
Column flow rate: 1.00 mL/min
Ionization method: EI method (70 eV)
Mass m/z: from 20 to 800
Data analyzing software: NIST 20 MASS SPECTRAL LIB. (available from National Institute of Standards and Technology)

An amount of the resin in terms of a solid content is not particularly limited and may be appropriately selected depending on the intended purpose. However, the amount is preferably 0.1% by mass or more but 30% by mass or less, more preferably 0.5% by mass or more but 30% by mass or less, still more preferably 0.5% by mass or more but 20% by mass or less, particularly preferably 0.5% by mass or more but 10% by mass or less, relative to the total amount of the active-energy-ray-curable composition. When the amount is 0.1% by mass or more, the resin hardly moves in the active-energy-ray-curable composition to increase viscosity, resulting in excellence in blocking resistance and close adhesiveness. The amount is 30% by mass or less, it is easy to allow the resin to move in the active-energy-ray-curable composition to lower viscosity, resulting in excellent drawability.

The amount of the resin can be measured by, for example, the gel permeation chromatography (GPC). Specifically, the active-energy-ray-curable composition is 3-fold diluted with tetrahydrofuran in terms of weight in the dark and is filtrated using a filter having an average pore diameter of 0.45 micro meters. Next, tetrahydrofuran as a solvent and monodispersion agent polystyrene (available from Tosoh Corporation) as a standard sample are used. Then, 0.02 mL of the diluted active-energy-ray-curable composition is injected into two columns (product name: TSKgel GMH_{HR}-N, available from Tosoh Corporation, particle diameter: 5 micro meters, inner diameter: 7.8 mm, length: 30 cm) at a flow rate of 1.0 mL/min and is detected using a refractive index detector (device name: RI-201, available from Showa Denko K.K., sensitivity: 64). An amount of the resin can be measured by performing data processing using GPC data processing system (available from Toray Research Center, Inc.).

<Active-Energy-Ray-Curable Compound>

The active-energy-ray-curable composition of the present disclosure preferably includes an active-energy-ray-curable compound. The active-energy-ray-curable compound is not particularly limited and may be appropriately selected depending on the intended purpose so long as the active-energy-ray-curable composition is a compound including one or more ethylenically unsaturated group that can be cured through irradiation of active energy rays. Examples of the active-energy-ray-curable compound include phenoxyethyl (meth)acrylate, tetrahydrofurfuryl (meth)acrylate, isobornyl (meth)acrylate, 2-hydroxyethyl (meth)acrylate, 4-hydroxybutyl (meth)acrylate, isobutyl (meth)acrylate, t-butyl (meth)acrylate, isooctyl (meth)acrylate, 2-methoxyethyl (meth)acrylate, methoxytriethylene glycol (meth)acrylate, 2-ethoxyethyl (meth)acrylate, 3-methoxybutyl (meth)acrylate, ethoxyethyl (meth)acrylate, butoxyethyl (meth)acrylate, ethoxydiethylene glycol (meth)acrylate, ethoxydiethylene glycol (meth)acrylate, methoxydixylethyl (meth)acrylate, ethyl diglycol (meth)acrylate, cyclic trimethylolpropane formal mono(meth)acrylate, imide (meth)acrylate, isoamyl (meth)acrylate, ethoxylated succinic acid (meth)acrylate, trifluoroethyl (meth)acrylate, ω-carboxypolycaprolactone mono(meth)acrylate, Nvinylformamide, cyclohexyl (meth)acrylate, benzyl (meth)acrylate, methylphenoxyethyl (meth)acrylate, 4-t-butylcyclohexyl (meth)acrylate, caprolactone-modified tetrahydrofurfuryl (meth)acrylate, tribromophenyl (meth)acrylate, ethoxylated tribromophenyl (meth)acrylate, 2-phenoxyethyl (meth)acrylate, acryloyl morpholine, phenoxydiethylene glycol (meth)acrylate, vinylcaprolactam, vinylpyrrolidone, 2-hydroxy-3-phenoxypropyl (meth)acrylate, 1,4-cyclohexanedimethanol mono(meth)acrylate, 2-(2-ethoxyethoxy)ethyl (meth)acrylate, stearyl (meth)acrylate, diethylene glycol monobutyl ether (meth)acrylate, lauryl (meth)acrylate, isodecyl (meth)acrylate, 3,3,5-trimethylcyclohexanol (meth)acrylate, isooctyl (meth)acrylate, octyl/decyl (meth)acrylate, tridecyl (meth)acrylate, caprolactone (meth)acrylate, ethoxylated (4) nonylphenol (meth)acrylate, methoxy polyethylene glycol (350) mono(meth)acrylate, methoxy polyethylene glycol (550) mono(meth)acrylate, hexanediol di(meth)acrylate, trimethylolpropane tri(meth)acrylate, pentaerythritol tri(meth)acrylate, polyethylene glycol di(meth)acrylate, dipropylene glycol di(meth)acrylate, tripropylene glycol tri(meth)acrylate, neopentyl glycol di(meth)acrylate, bispentaerythritol hexa(meth)acrylate, ethylene glycol di(meth)acrylate, diethylene glycol di(meth)acrylate, 1,6-hexanediol di(meth)acrylate, ethoxylated 1,6-hexanediol di(meth)acrylate, polypropylene glycol di(meth)acrylate, 1,4-butanediol di(meth)acrylate, 1,9-nonanediol di(meth)acrylate, tetraethylene glycol di(meth)acrylate, 2-n-butyl-2-ethyl 1,3-propanediol di(meth)acrylate, hydroxypivalic acid neopentyl glycol di(meth)acrylate, 1,3-butylene glycol di(meth)acrylate, trimethylolpropane tri(meth)acrylate, hydroxypivalic acid trimethylolpropane tri(meth)acrylate, ethoxylated phosphoric acid tri(meth)acrylate, ethoxylated tripropylene glycol di(meth)acrylate, neopentyl glycol-modified trimethylolpropane di(meth)acrylate, stearic acid-modified pentaerythritol di(meth)acrylate, pentaerythritol tri(meth)acrylate, tetramethylolpropane tri(meth)acrylate, tetramethylolmethane tri(meth)acrylate, pentaerythritol tetra(meth)acrylate, caprolactone-modified trimethylolpropane tri(meth)acrylate, propoxylate glyceryl tri(meth)acrylate, tetramethylolmethane tetra(meth)acrylate, pentaerythritol tetra(meth)acrylate, ditrimethylolpropane tetra(meth)acrylate, ethoxylated pentaerythritol tetra(meth)acrylate, dipentaerythritol hexa(meth)acrylate, caprolactone-modified dipentaerythritol hexa(meth)acrylate, dipentaerythritol hydroxypenta(meth)acrylate, neopentyl glycol oligo(meth)acrylate, 1,4-butanediol oligo(meth)acrylate, hydroxypivalic acid neopentyl glycol acrylic acid adduct, 1,6-hexanediol oligo(meth)acrylate, trimethylolpropane oligo(meth)acrylate, pentaerythritol oligo(meth)acrylate, ethoxylated neopentyl glycol di(meth)acrylate, propoxylated neopentyl glycol di(meth)acrylate, tripropylene glycol di(meth)acrylate, ethoxylated trimethylolpropane tri(meth)acrylate, propoxylated trimethylolpropane tri(meth)acrylate, and 2-(2-vinyloxyethoxy)ethyl acrylate. These may be used alone or in combination.

An amount of the active-energy-ray-curable compound is not particularly limited and may be appropriately selected depending on the intended purpose. The amount is preferably 25% by mass or more but 60% by mass or less, more preferably 35% by mass or more but 60% by mass or less, particularly preferably 45% by mass or more but 60% by mass or less, relative to the total amount of the active-energy-ray-curable composition. When the amount is 25% by mass or more, drawability can be improved in terms of a ratio (interaction) between the resin and the active-energy-ray-curable compound. When the amount is 60% by mass or less, blocking resistance and close adhesiveness can be improved in terms of a ratio (interaction) between the resin and the active-energy-ray-curable compound.

<Cross-Linking Agent>

The active-energy-ray-curable composition of the present disclosure preferably includes a cross-linking agent. When the active-energy-ray-curable composition includes the cross-linking agent, the resin is cross-linked in the active-energy-ray-curable composition, which makes it difficult to allow the resin to move. As a result, viscosity of the active-energy-ray-curable composition can increase to improve blocking resistance and close adhesiveness.

A degree of polymerization of the cross-linking agent is preferably 10% or more but 95% or less.

Whether the active-energy-ray-curable composition includes the cross-linking agent can be measured by, for example, the gas chromatography mass spectrometry (GC/MS). Specifically, whether the active-energy-ray-curable composition includes the cross-linking agent can be measured in the same manner as in the gas chromatography mass spectrometry used for judging whether the resin includes the benzene structure unit, except that the thermal deposition temperature (600 degrees Celsius) is changed to the heating temperature (180 degrees Celsius).

<Polymerization Initiator>

The active-energy-ray-curable composition of the present disclosure optionally contains a polymerization initiator. The polymerization initiator produces active species such as a radical or a cation upon application of energy of an active energy ray and initiates polymerization of a polymerizable compound (monomer or oligomer). As the polymerization initiator, it is suitable to use a known radical polymerization initiator, cation polymerization initiator, base producing agent, or a combination thereof. Of these, a radical polymerization initiator is preferable. Moreover, the polymerization initiator preferably accounts for 5 percent by weight to 20 percent by weight of the total content of the composition (100 percent by weight) to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds.

In addition, a polymerization accelerator (sensitizer) is optionally used together with the polymerization initiator. The polymerization accelerator is not particularly limited. Preferred examples thereof include, but are not limited to, amines such as trimethylamine, methyl dimethanol amine, triethanol amine, p-diethylamino acetophenone, p-dimethyl amino ethylbenzoate, p-dimethyl amino benzoate-2-ethylhexyl, N,N-dimthyl benzylamine and 4,4′-bis(diethylamino)benzophenone. The content thereof is determined depending on the identity (type) of the polymerization initiator and the content thereof.

<Polymerization Inhibitor>

The polymerization inhibitor can improve the active-energy-ray-curable composition in storing property (storage stability). In addition, the polymerization inhibitor can prevent head clogging caused by thermal polymerization in cases where the active-energy-ray-curable composition is heated to lower its viscosity and the resultant active-energy-ray-curable composition is ejected.

The polymerization inhibitor is not particularly limited and may be appropriately selected depending on the intended purpose. Examples of the polymerization inhibitor include 4-methoxy-1-naphthol, methylhydroquinone, hydroquinone, t-butylhydroquinone, di-t-butylhydroquinone, methoquinone, 2,2′-dihydroxy-3,3′-di(α-methylcyclohexyl)-5,5′-dimethyldiphenylmethane, p-benzoquinone, di-t-butyldiphenylamine, 9,10-di-n-butoxyanthracene, and 4,4′-[1,10-dioxo-1,10-decanediylbis(oxy)]bis[2,2,6,6-tetramethyl]-1-piperidinyloxy. These may be used alone or in combination.

An amount of the polymerization inhibitor is preferably 0.01% by mass or more but 10% by mass or less.

<Organic Solvent>

The active-energy-ray-curable composition of the present disclosure optionally contains an organic solvent although it is preferable to spare it. The curable composition free of an organic solvent, in particular volatile organic compound (VOC), is preferable because it enhances safety at where the composition is handled and makes it possible to prevent pollution of the environment. Incidentally, the organic solvent represents a conventional non-reactive organic solvent, for example, ether, ketone, xylene, ethyl acetate, cyclohexanone, and toluene, which is clearly distinguished from reactive monomers. Furthermore, “free of” an organic solvent means that no organic solvent is substantially contained. The content thereof is preferably less than 0.1 percent by mass.

<Active Energy Rays>

Active energy rays used for curing an active-energy-ray-curable composition of the present disclosure are not particularly limited, so long as they are able to give necessary energy for allowing polymerization reaction of polymerizable components in the composition to proceed. Examples of the active energy rays include electron beams, α-rays, β-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

<Preparation of Active-Energy-Ray-Curable Composition>

The active-energy-ray-curable composition of the present disclosure can be prepared by using the components described above. The preparation devices and conditions are not particularly limited. For example, the curable-composition can be prepared by subjecting a polymerizable monomer, a pigment, a dispersant, etc., to a dispersion treatment using a dispersing machine such as a ball mill, a kitty mill, a disk mill, a pin mill, and a DYNO-MILL to prepare a pigment liquid dispersion, and further mixing the pigment liquid dispersion with a polymerizable monomer, an initiator, a polymerization initiator, and a surfactant.

—Properties of Active-Energy-Ray-Curable Composition—

Properties of the active-energy-ray-curable composition are not particularly limited and may be appropriately selected from viscosity, surface tension, and pH depending on the intended purpose.

<Viscosity>

The viscosity of the active-energy-ray-curable composition of the present disclosure has no particular limit because it can be adjusted depending on the purpose and application devices. For example, if an ejecting device that ejects the composition from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees Celsius to 65 degrees Celsius, preferably at 25 degrees Celsius. In addition, it is particularly preferable to satisfy this viscosity range by the composition free of the organic solvent described above. Incidentally, the viscosity can be measured by a cone plate rotary viscometer (VISCOMETER TVE-22L, manufactured by TOKI SANGYO CO., LTD.) using a cone rotor (1° 34′×R24) at a number of rotation of 50 rpm with a setting of the temperature of hemathermal circulating water in the range of 20 degrees Celsius to 65 degrees Celsius. VISCOMATE VM-150III can be used for the temperature adjustment of the circulating water.

—Surface Tension—

A surface tension of the active-energy-ray-curable composition is preferably 35 mN/m or less, more preferably 32 mN/m or less, under the condition of 25 degrees Celsius. The surface tension can be measured using a fully automatic surface tensiometer (device name: CBVP-Z, available from Kyowa Interface Science Co., Ltd) at 25 degrees Celsius.

—pH—

A pH of the active-energy-ray-curable composition is preferably 7 or more but 12 or less, more preferably 8 or more but 11 or less in order to prevent a metal component to be wetted from corrosion.

The pH can be measured by, for example, a pH meter (device name: HM-30R, available from DKK-TOA CORPORATION).

(Active-Energy-Ray-Curable Composition Primer)

An active-energy-ray-curable composition primer of the present disclosure includes the active-energy-ray-curable composition of the present disclosure, and further includes other components such as a pigment if necessary.

As the active-energy-ray-curable composition primer, the same one as exemplified in the description of the active-energy-ray-curable composition of the present disclosure can be used. The active-energy-ray-curable composition primer can also be used as an ink.

(Cured Product)

A cured product of the present disclosure can be formed with at least one of the active-energy-ray-curable composition of the present disclosure and the active-energy-ray-curable composition primer of the present disclosure.

As the active-energy-ray-curable composition, the same one as exemplified in the description of the active-energy-ray-curable composition of the present disclosure can be used.

As the active-energy-ray-curable composition primer, the same one as exemplified in the description of the active-energy-ray-curable composition primer of the present disclosure can be used.

The cured product can be obtained by attaching at least one of the active-energy-ray-curable composition and the active-energy-ray-curable composition primer onto a recording medium to form a coated film on the recording medium and then curing the coated film.

The attaching can be suitably performed by the inkjet recording method.

The curing can be suitably performed through the active energy rays of the present disclosure.

—Close Adhesiveness—

The cured product of the present disclosure is measured for close adhesiveness by the cross-cut peel test according to the general test method for paints (former JIS standard) of JIS K5400. The number of the squares peeled in 100 test squares is preferably 25 or less, more preferably 10 or less. When the number of the squares peeled is 25 or less, the cured product is excellent in close adhesiveness.

—Drawability—

A percentage of the drawability of the cured product of the present disclosure is preferably 120% or more, more preferably 130% or more. When the percentage of the drawability is 120% or more, the cured product is excellent in drawability in terms of post-processing of printed matter.

The percentage of the drawability can be measured by the following method. Specifically, the dumbbell-shaped test piece (No. 6) according to JIS K6251 is pulled by a tensile testing machine (device name: AUTOGRAPH AGS-5kNX, available from SHIMADZU CORPORATION) at a rate of 20 mm/min at 180 degrees Celsius to measure breaking elongation at 180 degrees Celsius. The percentage of the drawability can be obtained by a ratio of (the length of the sample after the tensile test)/(the length of the sample before the tensile test).

(Processed Product)

A processed product of the present disclosure can be formed by drawing the cured product of the present disclosure.

As the cured product, the same one as exemplified in the description of the cured product of the present disclosure can be used.

The processed product can be obtained by drawing the cured product formed on the recording medium and drawing the cured product formed on the recording medium upon heating.

The processed product is preferably formed by heating the cured product with the recording medium and performing the drawing.

Examples of the processed product include panels for operation parts and measuring parts of automobiles, OA apparatuses, electrical/electronic appliances, and cameras. The processed product can be suitably applied to the automobiles, the OA apparatuses, the electrical/electronic appliances, and the cameras where the surface is necessarily molded after the decoration.

<Composition Stored Container>

The composition stored container of the present disclosure contains the active-energy-ray-curable composition and is suitable for the applications as described above. For example, if the active-energy-ray-curable composition of the present disclosure is used for ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

<Image Forming Method and Image Forming Apparatus>

The image forming method of the present disclosure includes at least an irradiating step of irradiating the curable composition of the present disclosure with an active energy ray to cure the curable composition. The image forming apparatus of the present disclosure includes at least an irradiator to irradiate the curable composition of the present disclosure with an active energy ray and a storing part containing the active-energy-ray-curable composition of the present disclosure. The storing part may include the container mentioned above. Furthermore, the method and the apparatus may respectively include a discharging step and a discharging device to discharge the active energy ray curable composition. The method of discharging the curable composition is not particularly limited, and examples thereof include a continuous jetting method and an on-demand method. The on-demand method includes a piezo method, a thermal method, an electrostatic method, etc.

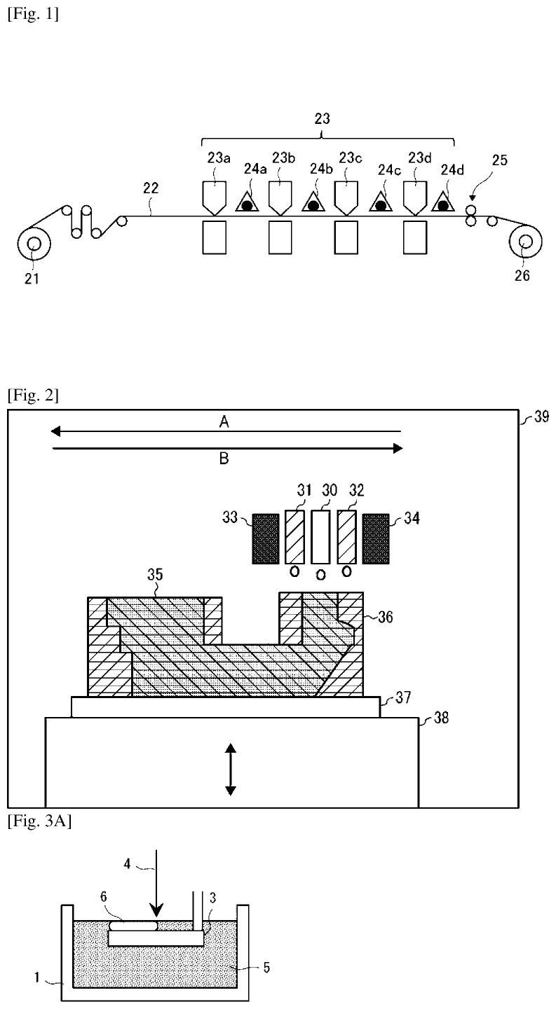

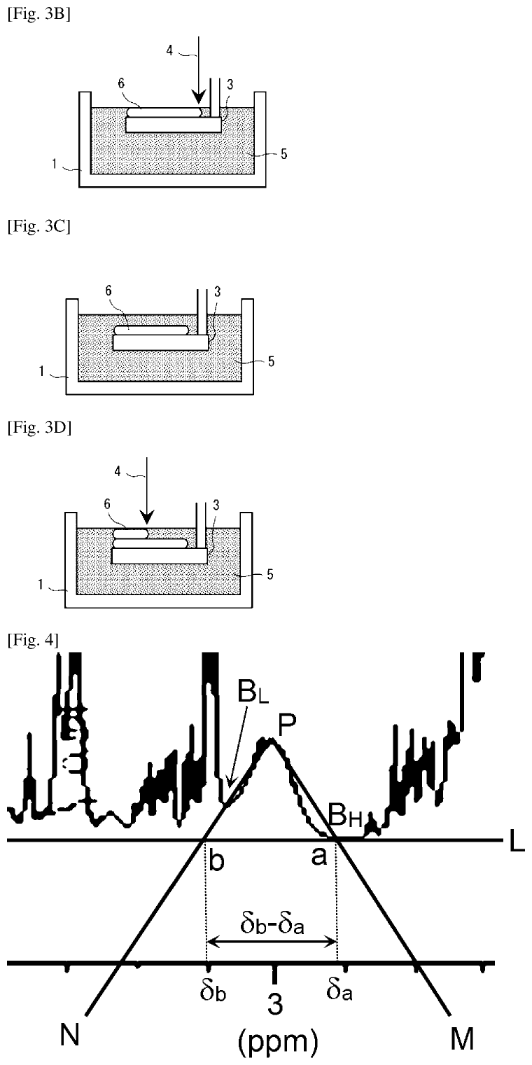

FIG. 1 is a diagram illustrating a two-dimensional image forming apparatus equipped with an inkjet discharging device. Printing units 23a, 23b, 23c, and 23d respectively having ink cartridges and discharging heads for yellow, magenta, cyan, and black active-energy-ray-curable inks discharge the inks onto a recording medium 22 fed from a supplying roller 21. Thereafter, light sources 24a, 24b, 24c, and 24d configured to cure the inks emit active energy rays to the inks, thereby curing the inks to form a color image. Thereafter, the recording medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the recording medium to around room temperature in a contact or non-contact manner. In addition, the inkjet recording method may be either of serial methods or line methods. The serial methods include discharging an ink onto a recording medium by moving the head while the recording medium intermittently moves according to the width of a discharging head. The line methods include discharging an ink onto a recording medium from a discharging head held at a fixed position while the recording medium continuously moves.

The recording medium 22 as a recording medium is not particularly limited and may be appropriately selected depending on the intended purpose. Examples thereof include paper, cloth, an impermeable substrate, and a building material.

Examples of the paper include plain paper, gloss paper, special paper, and general printing paper.

Examples of the cloth include cloth to be used for clothes (e.g., T-shirts), textiles, and leather.

Examples of the impermeable substrate include plastic films and metals.

Examples of the plastic films include a polycarbonate film, a vinyl chloride resin film, a polyethylene terephthalate (PET) film, a polypropylene film, and a polyethylene film. Examples of the building material include wall paper, flooring, tiles, ceramics, and glass. These may be used alone or in combination.

Among them, a polycarbonate film, a polyethylene terephthalate film, and a polypropylene film are preferable as the recording medium, in terms of close adhesiveness of the active-energy-ray-curable composition primer or the cured product. Optionally, multiple colors can be printed with no or weak active energy ray from the light sources 24a, 24b, and 24c followed by irradiation of the active energy ray from the light source 24d. As a result, energy and cost can be saved.

The recorded matter having images printed with the ink of the present disclosure includes articles having printed images or texts on a plain surface of conventional paper, resin film, etc., a rough surface, or a surface made of various materials such as metal or ceramic. In addition, by laminating layers of images in part or the entire of a recording medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first active-energy-ray-curable composition, and ejection head units 31 and 32 for support and curing these compositions ejects a second active-energy-ray-curable composition having a different composition from the first active-energy-ray-curable composition, while ultraviolet irradiators 33 and 34 adjacent to the ejection head units 31 and 32 cure the compositions. To be more specific, for example, after the ejection head units 31 and 32 for support eject the second active-energy-ray-curable composition onto a substrate 37 for additive manufacturing and the second active-energy-ray-curable composition is solidified by irradiation of an active energy ray to form a first substrate layer having a space for composition, the ejection head unit 30 for additive manufacturing ejects the first active-energy-ray-curable composition onto the pool followed by irradiation of an active energy ray for solidification, thereby forming a first additive manufacturing layer. This step is repeated multiple times lowering the stage 38 movable in the vertical direction to laminate the supporting layer (or support layer) and the additive manufacturing layer to fabricate a solid object 35. Thereafter, an additive manufacturing support 36 is removed, if desired. Although only a single ejection head unit 30 for additive manufacturing is provided to the image forming apparatus illustrated 39 in FIG. 2, it can have two or more units 30.

### EXAMPLES

The present disclosure will be described in more detail by way of the following Examples and Comparative Examples. However, the present disclosure should not be construed as being limited to these Examples.

As described below, the “¹H-NMR spectrum” was measured to calculate the “ratio (S₃/S₃₀)” and the “G value”.

<¹H-NMR Spectrum>

The active-energy-ray-curable composition as prepared below was measured for the ¹H-NMR spectrum using a Fourier transform nuclear magnetic resonance (NMR) device (500 MHz, device name: ECX-500, available from JEOL Ltd.). Note that, measurement conditions are as follows.

—Measurement Conditions—
Temperature: 24 degrees Celsius or more but 26 degrees Celsius or less
Pulse width: 6.3 micro seconds (45°)
Waiting time: 20.0 seconds
Observed frequency: 9,000 Hz
Data points: 32,768
Cumulative number: 64 times
Standard substance: 0.03% by mass of tetramethylsilane (TMS)
Solvent: deuterated chloroform (CDCl₃)
Concentration of active-energy-ray-curable composition: 1.0% by mass and 3.0% by mass
Analysis software: Mest Re Nova (available from Mestrelab Research)

<Ratio (S₃/S₃₀)>

Hereinafter, regarding one signal, a point at which intensity of the signal is the highest is referred to as “peak” and a point at which a difference of a chemical shift between the peak and the point is the smallest and has the lowest intensity of the signal is referred to as “bottom”. The bottom includes a point at which adjacent signals are at least partially overlapped.

In the ¹H-NMR spectrum where a concentration of the active-energy-ray-curable composition obtained was 3.0% by mass, analysis software (product name: Delta v5.0.5, available from JEOL Ltd.) was used to draw a base line L. Then, a straight line M connecting the peak and the bottom at a side of the high magnetic field and a straight line N connecting the peak and the bottom at a side of the low magnetic field were drawn. An intersection point of the L and the M was referred to as “a” and an intersection point of the L and the N was referred to as “b”.

With the analysis software, an integrated value of all signals in the ¹H-NMR spectrum is referred to as “S₃₀”. Moreover, with the analysis software, at least one broad signal having a difference of 0.1 ppm or more was selected, where the difference was determined by subtracting a chemical shift δₐ in the a from a chemical shift δ_{b} in the b. An integrated value of the at least one broad signal selected was referred to as S₃.

From the S₃ and the S₃₀ obtained, a ratio (S₃/S₃₀) of the S₃ to the S₃₀ was calculated.

<G Value>

In a ¹H-NMR spectrum where a concentration of the active-energy-ray-curable composition obtained was 1.0% by mass, S₁ and S₁₀ were obtained in the same manner as in the case of the ¹H-NMR spectrum where a concentration of the active-energy-ray-curable composition obtained was 3.0% by mass.

From the S₃, S₃₀, S₁, and S₁₀ obtained, a G value of the active-energy-ray-curable composition prepared as described below was calculated using the following Formula (1).

G value=S₃/(S₃₀+S₁₀)−S₁/(S₃₀+S₁₀) Formula (1)

### Example 1

Isobornyl acrylate (available from Osaka Organic Chemical Industry Ltd.) (57.70% by mass), phenoxyethyl acrylate (available from Osaka Organic Chemical Industry Ltd.) (41.20% by mass), 2,4,6-trimethylbenzoyl-diphenyl-phosphine oxide (product name: IRGACURE TPO, available from BASF) (1.00% by mass), and resin A2 (butadiene resin, product name: B-1000, available from Nippon Soda Co., Ltd., weight average molecular weight: 1×10³) (0.10% by mass) were added in this order upon stirring. After stirring for 1 hour, it was confirmed that there was not any material that remained undissolved. The resultant was filtrated through a membrane filter to obtain an active-energy-ray-curable composition (yield: 99.5%).

### Examples 2 to 48 and Comparative Examples 1 to 6

Active-energy-ray-curable compositions of Examples 2 to 48 and Comparative Examples 1 to 6 were prepared in the same manner as in Example 1 except that the formulation of Example 1 was changed as presented in the following Tables 1-1 to 7-2.

Next, “blocking resistance”, “close adhesiveness”, and “drawability” were evaluated in the following manners. Results are presented in the following Tables 1-1 to 7-2.

—Preparation of Cured Product—

On a polycarbonate film (product name: IUPILON⋅FILM FE-2000, available from Mitsubishi Engineering-Plastics Corporation, one-side masking, average thickness: 100 micro meters), the active-energy-ray-curable composition obtained was coated using a wire bar (product name: winding No. #6, available from Kobayashi Engineering Works Ltd.). A solid coated film having a thickness of about 10 micro meters was irradiated with active energy rays (wavelength of 350 nm or more but 400 nm or less and integral of light of 1,500 mJ/cm²) using an UV irradiator (device name: Light Hammer 6, available from Fusion Systems Japan) to obtain a cured product.

<Evaluation of Blocking Resistance>

According to the “JAPAN TAPPI T477 paper pulp test method” issued by Japan Technical Association of the Pulp and Paper Industry, blocking resistance was evaluated. Specifically, the aforementioned cured product (6 cm×6 cm), which was obtained by curing the active-energy-ray-curable composition, was stacked on a glass plate (10 cm×10 cm). Then, a sheet of coat paper for industrial printing, which had not been printed thereon, was stacked on the cured product. A glass plate (10 cm×10 cm) was stacked on the sheet of coat paper and was applied with a load of 1 kg/m². The plate obtained was left to stand for 24 hours under the following conditions (temperature of 40 degrees Celsius and relative humidity of 90%) and was further left to stand for 2 hours at room temperature. Then, the sheet of coat paper for industrial printing was peeled and a degree of attaching the cured product upon peering was observed. Note that, the blocking resistance satisfying A, B, C, D, or E based on the following evaluation criteria is a practically usable level.

—Evaluation Criteria—

A: The surface of the coat paper adjacent to the cured product can be freely slid.

B: The surface of the coat paper adjacent to the cured product cannot be freely slid. However, when the surface is rubbed with the surface being pressed, the surface can be smoothly slid.

C: The surface of the coat paper adjacent to the cured product cannot be freely slid. However, when the surface is rubbed with the surface being pressed, the surface can be slid.

D: The surface of the coat paper adjacent to the cured product cannot be freely slid. However, when the surface is rubbed with the surface being pressed, the surface can be slightly slid.

E: The surface of the coat paper adjacent to the cured product cannot be easily peeled.

F: The surface of the coat paper adjacent to the cured product is closely adhered to the cured product to be integrated.

<Evaluation of Close Adhesiveness>

The cured product on the polycarbonate film was subjected to the cross-cut peel test according to the general test method for paints (former JIS standard) of JIS K5400 using a cloth adhesive tape (product name: 123LW-50, available from Nichiban Co., Ltd.). The number of the squares peeled in 100 test squares was counted and the “close adhesiveness” to the substrate was evaluated based on the following evaluation criteria. Note that, the close adhesiveness satisfying A, B, C, D, or E based on the following evaluation criteria is a practically usable level.

—Evaluation Criteria—

A: The number of the squares peeled is 5 or less.

B: The number of the squares peeled is more than 5 but 10 or less.

C: The number of the squares peeled is more than 10 but 15 or less.

D: The number of the squares peeled is more than 15 but 20 or less.

E: The number of the squares peeled is more than 20 but 25 or less.

F: The number of the squares peeled is more than 25.

<Evaluation of Drawability>

As a sample, a dumbbell-shaped test piece (No. 6) according to JIS K6251 of the cured product obtained in the —Preparation of Cured Product— was pulled with the cured product being on the polycarbonate film by a tensile testing machine (device name: AUTOGRAPH AGS-5kNX, available from SHIMADZU CORPORATION) at a rate of 20 mm/min at 180 degrees Celsius to measure breaking elongation at 180 degrees Celsius. A length of the sample before the tensile test and a length of the sample after the tensile test were measured. The drawability was evaluated based on a ratio of (the length of the sample after the tensile test)/(the length of the sample before the tensile test). Here, the drawability satisfying A, B, C, D, or E based on the following evaluation criteria is a practically usable level.

—Evaluation Criteria—

A: 160% or more

B: 150% or more but less than 160%

C: 140% or more but less than 150%

D: 130% or more but less than 140%

E: 120% or more but less than 130%

F: Less than 120%

TABLE 1-1

| | | Example | | | |
|---|---|---|---|---|---|
| | | 1 | 2 | 3 | 4 |
| Active-energy- | Isobornyl acrylate | 57.70 | — | 57.50 | — |
| ray-curable | Phenoxyethyl acrylate | 41.20 | — | 41.00 | — |
| compound | 2-(2-Vinyloxyethoxy)ethyl acrylate | — | 57.70 | — | 57.50 |
| | Hydroxypivalic acid neopentylglycol acrylic | — | 41.20 | — | 41.00 |
| | acid adduct | | | | |
| | Isooctyl acrylate | — | — | — | — |
| | Tetrahydrofurfuryl acrylate | — | — | — | — |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.10 | 0.10 | 0.50 | 0.50 |
| | molecular weight: 1 × 10 [symbol] ) | | | | |
| | Resin A3: acrylic resin (weight average | — | — | — | — |
| | molecular weight: 1 × 10 [symbol] , | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | — | — | — | — |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | — | — | — | — |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.31 | 0.30 | 0.34 | 0.32 |
| G value | | 0.06 | 0.05 | 0.14 | 0.12 |
| Evaluation | Blocking resistance | E | E | D | D |
| criteria | Close adhesiveness | E | E | E | E |
| | Drawability | A | A | A | A |

[symbol]

indicates data missing or illegible when filed

TABLE 1-2

| | | Example | | | |
|---|---|---|---|---|---|
| | | 5 | 6 | 7 | 8 |
| Active-energy- | Isobornyl acrylate | 57.50 | — | 57.00 | 57.00 |
| ray-curable | Phenoxyethyl acrylate | 41.00 | — | 41.00 | 41.00 |
| compound | 2-(2-Vinyloxyethoxy)ethyl acrylate | — | 57.50 | — | — |
| | Hydroxypivalic acid neopentylglycol acrylic | — | 41.00 | — | — |
| | acid adduct | | | | |
| | Isooctyl acrylate | — | — | — | — |
| | Tetrahydrofurfuryl acrylate | — | — | — | — |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.25 | 0.25 | 0.50 | 1.00 |
| | molecular weight: 1 × 10 [symbol] ) | | | | |
| | Resin A3: acrylic resin (weight average | — | — | — | — |
| | molecular weight: 1 × 10 [symbol] , | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | 0.25 | 0.25 | 0.50 | 1.00 |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | — | — | — | — |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.38 | 0.38 | 0.42 | 0.43 |
| G value | | 0.2 [symbol] | 0.18 | 0.32 | 0. [symbol] 4 |
| Evaluation | Blocking resistance | C | C | C | B |
| criteria | Close adhesiveness | D | E | C | C |
| | Drawability | B | B | C | C |

[symbol]

indicates data missing or illegible when filed

TABLE 2-1

| | | Example | | | |
|---|---|---|---|---|---|
| | | 9 | 10 | 11 | 12 |
| Active-energy- | Isobornyl acrylate | 55.00 | 54.00 | 52.00 | 46.00 |
| ray-curable | Phenoxyethyl acrylate | 40.00 | 39.00 | 37.00 | 33.00 |
| compound | 2-(2-Vinyloxyethoxy)ethyl acrylate | — | — | — | — |
| | Hydroxypivalic acid neopentylglycol acrylic | — | — | — | — |
| | acid adduct | | | | |
| | Isooctyl acrylate | — | — | — | — |
| | Tetrahydrofurfuryl acrylate | — | — | — | — |
| Resin | Resin A1: epoxy resin (weight average | — | — | — | — |
| | molecular weight: 500, having unit of | | | | |
| | benzene structure) | | | | |
| | Resin A2: butadiene resin (weight average | 2.00 | 3.00 | 5.00 | 10.00 |
| | molecular weight: 1 × 10 [symbol] ) | | | | |
| | Resin A3: acrylic resin (weight average | — | — | — | — |
| | molecular weight: 1 × 10 [symbol] , | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | 2.00 | 3.00 | 5.00 | 10.00 |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | — | — | — | — |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.47 | 0.49 | 0.51 | 0.53 |
| G value | | 0.39 | 0.44 | 0.46 | 0.48 |
| Evaluation | Blocking resistance | B | B | B | A |
| criteria | Close adhesiveness | B | B | B | B |
| | Drawability | C | D | D | D |

[symbol]

indicates data missing or illegible when filed

TABLE 2-2

| | | Example | | | |
|---|---|---|---|---|---|
| | | 13 | 14 | 15 | 16 |
| Active-energy- | Isobornyl acrylate | 40.00 | — | — | — |
| ray-curable | Phenoxyethyl acrylate | 29.00 | — | — | — |
| compound | 2-(2-Vinyloxyethoxy)ethyl acrylate | — | 57.00 | 57.00 | 55.00 |
| | Hydroxypivalic acid neopentylglycol acrylic | — | 41.00 | 40.00 | 40.00 |
| | acid adduct | | | | |
| | Isooctyl acrylate | — | — | — | — |
| | Tetrahydrofurfuryl acrylate | — | — | — | — |
| Resin | Resin A1: epoxy resin (weight average | — | — | — | — |
| | molecular weight: 500, having unit of | | | | |
| | benzene structure) | | | | |
| | Resin A2: butadiene resin (weight average | 15.00 | 0.50 | 1.00 | 2.00 |
| | molecular weight: 1 × 10 [symbol] ) | | | | |
| | Resin A3: acrylic resin (weight average | — | — | — | — |
| | molecular weight: 1 × 10 [symbol] , | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | 15.00 | 0.50 | 1.00 | 2.00 |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | — | — | — | — |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.55 | 0.41 | 0.42 | 0.44 |
| G value | | 0.49 | 0.29 | 0.31 | 0.33 |
| Evaluation | Blocking resistance | A | C | C | B |
| criteria | Close adhesiveness | B | C | C | C |
| | Drawability | D | C | C | C |

[symbol]

indicates data missing or illegible when filed

TABLE 3-1

| | | Example | | |
|---|---|---|---|---|
| | | 17 | 18 | 19 |
| Active-energy- | Isobornyl acrylate | — | — | — |
| ray-curable | Phenoxyethyl acrylate | — | — | — |
| compound | 2-(2-Vinyloxyethoxy)ethyl acrylate | 54.00 | 52.00 | 46.00 |
| | Hydroxypivalic acid neopentylglycol acrylic | 39.00 | 37.00 | 33.00 |
| | acid adduct | | | |
| | Isooctyl acrylate | — | — | — |
| | Tetrahydrofurfuryl acrylate | — | — | — |
| Resin | Resin A1: epoxy resin (weight average | — | — | — |
| | molecular weight: 500, having unit of | | | |
| | benzene structure) | | | |
| | Resin A2: butadiene resin (weight average | 3.00 | 5.00 | 10.00 |
| | molecular weight: 1 × 10 [symbol] ) | | | |
| | Resin A3: acrylic resin (weight average | — | — | — |
| | molecular weight: 1 × 10⁴, | | | |
| | having unit of benzene structure) | | | |
| | Resin A4: ether resin (weight average | — | — | — |
| | molecular weight: 1 × 10⁷) | | | |
| | Resin B1: epoxy resin (weight average | 3.00 | 5.00 | 10.00 |
| | molecular weight: 500, having unit of | | | |
| | benzene structure) | | | |
| | Resin B2: acrylic resin (weight average | — | — | — |
| | molecular weight: 1 × 10⁴) | | | |
| | Resin B3: acrylic resin (weight average | — | — | — |
| | molecular weight: 1 × 10 [symbol] ) | | | |
| | Resin B4: ether resin (weight average | — | — | — |
| | molecular weight: 1 × 10⁷) | | | |
| | Resin C: styrene acrylic resin (weight average | — | — | — |
| | molecular weight: 1 × 10 [symbol] , | | | |
| | having unit of benzene structure) | | | |
| Cross-linking | Isophorone diisocyanate (degree of | — | — | — |
| agent | polymerization: 10%) | | | |
| | Isophorone diisocyanate (degree of | — | — | — |
| | polymerization: 50%) | | | |
| | Isophorone diisocyanate (degree of | — | — | — |
| | polymerization: 95%) | | | |
| | Trimethylolpropane acrylate (degree of | — | — | — |
| | polymerization: 10%) | | | |
| | Unit of urethane structure and | — | — | — |
| | 6-functional resin | | | |
| Polymerization | 2,4,6-Trimethylbenzoyl-diphenyl-phosphine | 1.00 | 1.00 | 1.00 |
| initiator | oxide | | | |
| Total (% by mass) | | 100.00 | 100.00 | 100.00 |
| Ratio (S₃/S₃₀) | | 0.47 | 0.48 | 0.50 |
| G value | | 0.37 | 0.43 | 0.45 |
| Evaluation | Blocking resistance | B | B | B |
| criteria | Close adhesiveness | B | B | B |
| | Drawability | C | D | D |

[symbol]

indicates data missing or illegible when filed

TABLE 3-2

| | | Example | | |
|---|---|---|---|---|
| | | 20 | 21 | 22 |
| Active-energy- | Isobornyl acrylate | — | 57.50 | 57.50 |
| ray-curable | Phenoxyethyl acrylate | — | 41.00 | 41.00 |
| compound | 2-(2-Vinyloxyethoxy)ethyl acrylate | 41.00 | — | — |
| | Hydroxypivalic acid neopentylglycol acrylic | 29.00 | — | — |
| | acid adduct | | | |
| | Isooctyl acrylate | — | — | — |
| | Tetrahydrofurfuryl acrylate | — | — | — |
| Resin | Resin A1: epoxy resin (weight average | — | — | — |
| | molecular weight: 500, having unit of | | | |
| | benzene structure) | | | |
| | Resin A2: butadiene resin (weight average | 15.00 | 0.25 | — |
| | molecular weight: 1 × 10³) | | | |
| | Resin A3: acrylic resin (weight average | — | — | 0.25 |
| | molecular weight: 1 × 10⁴, | | | |
| | having unit of benzene structure) | | | |
| | Resin A4: ether resin (weight average | — | — | — |
| | molecular weight: 1 × 10⁷) | | | |
| | Resin B1: epoxy resin (weight average | — | — | — |
| | molecular weight: 500, having unit of | | | |
| | benzene structure) | | | |
| | Resin B2: acrylic resin (weight average | 15.00 | — | — |
| | molecular weight: 1 × 10 [symbol] ) | | | |
| | Resin B3: acrylic resin (weight average | — | 0.25 | 0.25 |
| | molecular weight: 1 × 10 [symbol] ) | | | |
| | Resin B4: ether resin (weight average | — | — | — |
| | molecular weight: 1 × 10⁷) | | | |
| | Resin C: styrene acrylic resin (weight average | — | — | — |
| | molecular weight: 1 × 10 [symbol] , | | | |
| | having unit of benzene structure) | | | |
| Cross-linking | Isophorone diisocyanate (degree of | — | — | — |
| agent | polymerization: 10%) | | | |
| | Isophorone diisocyanate (degree of | — | — | — |
| | polymerization: 50%) | | | |
| | Isophorone diisocyanate (degree of | — | — | — |
| | polymerization: 95%) | | | |
| | Trimethylolpropane acrylate (degree of | — | — | — |
| | polymerization: 10%) | | | |
| | Unit of urethane structure and | — | — | — |
| | 6-functional resin | | | |
| Polymerization | 2,4,6-Trimethylbenzoyl-diphenyl-phosphine | 1.00 | 1.00 | 1.00 |
| initiator | oxide | | | |
| Total (% by mass) | | 100.00 | 100.00 | 100.00 |
| Ratio (S₃/S₃₀) | | 0.52 | 0.44 | 0.45 |
| G value | | 0.47 | 0.35 | 0.37 |
| Evaluation | Blocking resistance | A | B | B |
| criteria | Close adhesiveness | B | C | B |
| | Drawability | D | C | C |

[symbol]

indicates data missing or illegible when filed

TABLE 4-1

| | | Example | | | |
|---|---|---|---|---|---|
| | | 23 | 24 | 25 | 26 |
| Active-energy- | Isobornyl acrylate | 57.50 | 57.50 | 57.50 | — |
| ray-curable | Phenoxyethyl acrylate | 41.00 | 41.00 | 41.00 | — |
| compound | 2-(2-Vinyloxyethoxy)ethyl acrylate | — | — | — | 57.50 |
| | Hydroxypivalic acid neopentylglycol acrylic | — | — | — | 41.00 |
| | acid adduct | | | | |
| | Isooctyl acrylate | — | — | — | — |
| | Tetrahydrofurfuryl acrylate | — | — | — | — |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.10 | 0.20 | 0.30 | 0.10 |
| | molecular weight: 1 × 10 [symbol] ) | | | | |
| | Resin A3: acrylic resin (weight average | — | — | — | — |
| | molecular weight: 1 × 10⁴, | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | — | — | — | — |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | 0.40 | 0.30 | 0.20 | 0.40 |
| | molecular weight: 1 × 10 [symbol] , | | | | |
| | having unit of benzene structure) | | | | |
| Cross-linking | Isophorone diisocyanate (degree of | — | — | — | — |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.49 | 0.47 | 0.44 | 0.47 |
| G value | | 0.42 | 0.39 | 0.37 | 0.41 |
| Evaluation | Blocking resistance | B | B | B | B |
| criteria | Close adhesiveness | B | B | C | B |
| | Drawability | C | C | C | C |

[symbol]

indicates data missing or illegible when filed

TABLE 4-2

| | | Example | | | |
|---|---|---|---|---|---|
| | | 27 | 28 | 29 | 30 |
| Active-energy- | Isobornyl acrylate | — | — | — | 57.70 |
| ray-curable | Phenoxyethyl acrylate | — | — | 57.70 | — |
| compound | 2-(2-Vinyloxyethoxy)ethyl acrylate | 57.50 | 57.50 | — | — |
| | Hydroxypivalic acid neopentylglycol acrylic | 41.00 | 41.00 | — | — |
| | acid adduct | | | | |
| | Isooctyl acrylate | — | — | 41.20 | — |
| | Tetrahydrofurfuryl acrylate | — | — | — | 41.20 |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.20 | 0.30 | 0.10 | 0.10 |
| | molecular weight: 1 × 10 [symbol] ) | | | | |
| | Resin A3: acrylic resin (weight average | — | — | — | — |
| | molecular weight 1 × 10 [symbol] , | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | — | — | — | — |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | 0.30 | 0.20 | — | — |
| | molecular weight: 1 × 10 [symbol] , | | | | |
| | having unit of benzene structure) | | | | |
| Cross-linking | Isophorone diisocyanate (degree of | — | — | — | — |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | — | — | — | — |
| initiator | oxide | | | | |
| Total (% by mass) | | 1.00 | 1.00 | 1.00 | 1.00 |
| Ratio (S₃/S₃₀) | | 100.00 | 100.00 | 100.00 | 100.00 |
| G value | | 0.45 | 0.42 | 0.30 | 0.32 |
| Evaluation | Blocking resistance | 0.36 | 0.31 | 0.05 | 0.07 |
| criteria | Close adhesiveness | B | C | E | E |
| | Drawability | C | C | E | E |
| | | C | C | A | A |

[symbol]

indicates data missing or illegible when filed

TABLE 5-1

| | | Example | | | |
|---|---|---|---|---|---|
| | | 31 | 32 | 33 | 34 |
| Active-energy- | Isobornyl acrylate | — | 57.50 | — | — |
| ray-curable | Phenoxyethyl acrylate | 57.50 | — | 57.00 | 55.70 |
| compound | 2-(2-Vinyloxyethoxy)ethyl acrylate | — | — | — | — |
| | Hydroxypivalic acid neopentylglycol acrylic | — | — | — | — |
| | acid adduct | | | | |
| | Isooctyl acrylate | 41.00 | — | 40.50 | 39.80 |
| | Tetrahydrofurfuryl acrylate | — | 41.00 | — | — |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.50 | 0.50 | 0.50 | 0.50 |
| | molecular weight: 1 × 10 [symbol] ) | | | | |
| | Resin A3: acrylic resin (weight average | — | — | — | — |
| | molecular weight: 1 × 10⁴, | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | — | — | — | — |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | — | — | 1.00 | 3.00 |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.33 | 0.35 | 0.37 | 0.45 |
| G value | | 0.11 | 0.14 | 0.18 | 0.36 |
| Evaluation | Blocking resistance | D | D | C | B |
| criteria | Close adhesiveness | E | E | D | C |
| | Drawability | A | A | B | C |

[symbol]

indicates data missing or illegible when filed

TABLE 5-2

| | | Example | | | |
|---|---|---|---|---|---|
| | | 35 | 36 | 37 | 38 |
| Active-energy- | Isobornyl acrylate | — | 57.00 | 55.70 | 54.50 |
| ray-curable | Phenoxyethyl acrylate | 54.50 | — | — | — |
| compound | 2-(2-Vinyloxyethoxy)ethyl acrylate | — | — | — | — |
| | Hydroxypivalic acid neopentylglycol acrylic | — | — | — | — |
| | acid adduct | | | | |
| | Isooctyl acrylate | 39.00 | — | — | — |
| | Tetrahydrofurfuryl acrylate | — | 40.50 | 39.80 | 39.00 |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.50 | 0.50 | 0.50 | 0.50 |
| | molecular weight: 1 × 10 [symbol] ) | | | | |
| | Resin A3: acrylic resin (weight average | — | — | — | — |
| | molecular weight: 1 × 10⁴, | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | — | — | — | — |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | 5.00 | 1.00 | 3.00 | 5.00 |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | — | — | — | — |
| | polymerization: 10%) | | | | |
| | Unit of urethane structure and 6-functional | — | — | — | — |
| | resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.51 | 0.40 | 0.48 | 0.54 |
| G value | | 0.47 | 0.25 | 0.40 | 0.47 |
| Evaluation | Blocking resistance | B | C | B | A |
| criteria | Close adhesiveness | B | D | B | B |
| | Drawability | D | B | C | D |

[symbol]

indicates data missing or illegible when filed

TABLE 6-1

| | | Example | | | |
|---|---|---|---|---|---|
| | | 39 | 40 | 41 | 42 |
| Active-energy- | Isobornyl acrylate | — | — | 57.00 | 57.00 |
| ray-curable | Phenoxyethyl acrylate | 57.00 | 57.00 | — | — |
| compound | 2-(2-Vinyloxyethoxy)ethyl acrylate | — | — | — | — |
| | Hydroxypivalic acid neopentylglycol acrylic | — | — | — | — |
| | acid adduct | | | | |
| | Isooctyl acrylate | 40.50 | 40.50 | — | — |
| | Tetrahydrofurfuryl acrylate | — | — | 40.50 | 40.50 |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.50 | 0.50 | 0.50 | 0.50 |
| | molecular weight: 1 × 10 [symbol] ) | | | | |
| | Resin A3: acrylic resin (weight average | — | — | — | — |
| | molecular weight: 1 × 10⁴, | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | — | — | — | — |
| | molecular weight: 1 × 10 [symbol] ) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | — | — | — | — |
| agent | polymerization: 10%) | | | | |
| | Isophorone diisocyanate (degree of | 1.00 | — | 1.00 | — |
| | polymerization: 50%) | | | | |
| | Isophorone diisocyanate (degree of | — | 1.00 | — | 1.00 |
| | polymerization: 95%) | | | | |
| | Trimethylolpropane acrylate (degree of | — | — | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.44 | 0.55 | 0.47 | 0.58 |
| G value | | 0. [symbol] 5 | 0.49 | 0.38 | 0.50 |
| Evaluation | Blocking resistance | B | A | B | A |
| criteria | Close adhesiveness | C | B | B | B |
| | Drawability | C | D | C | D |

[symbol]

indicates data missing or illegible when filed

TABLE 6-2

| | | Example | | | |
|---|---|---|---|---|---|
| | | 43 | 44 | 45 | 46 |
| Active-energy- | Isobornyl acrylate | — | 57.00 | — | 57.00 |
| ray-curable | Phenoxyethyl acrylate | 57.00 | — | 57.00 | — |
| compound | 2-(2-Vinyloxyethoxy)ethyl acrylate | — | — | — | — |
| | Hydroxypivalic acid neopentylglycol acrylic | — | — | — | — |
| | acid adduct | | | | |
| | Isooctyl acrylate | 40.50 | — | 40.50 | — |
| | Tetrahydrofurfuryl acrylate | — | 40.50 | — | 40.50 |
| Resin | Resin A1: epoxy resin (weight average | — | — | — | — |
| | molecular weight: 500, having unit of | | | | |
| | benzene structure) | | | | |
| | Resin A2: butadiene resin (weight average | 0.50 | 0.50 | 0.25 | 0.25 |
| | molecular weight: 1 × 10 [symbol] ) | | | | |
| | Resin A3: acrylic resin (weight average | — | — | — | — |
| | molecular weight: 1 × 10⁴, | | | | |
| | having unit of benzene structure) | | | | |
| | Resin A4: ether resin (weight average | — | — | — | — |
| | molecular weight: 1 × 10⁷) | | | | |
| | Resin B1: epoxy resin (weight average | — | — | — | — |
| | molecular weight: 500, having unit of | | | | |
| | benzene structure) | | | | |
| | Resin B2: acrylic resin (weight average | — | — | 0.25 | 0.25 |
| | molecular weight: 1 × 10⁴) | | | | |
| | Resin B3: acrylic resin (weight average | — | — | — | — |
| | molecular weight: 1 × 10 [symbol] ) | | | | |
| | Resin B4: ether resin (weight average | — | — | — | — |
| | molecular weight: 1 × 10⁷) | | | | |
| | Resin C: styrene acrylic resin (weight average | — | — | — | — |
| | molecular weight: 1 × 10 [symbol] , | | | | |
| | having unit of benzene structure) | | | | |
| Cross-linking | Isophorone diisocyanate (degree of | — | — | 1.00 | 1.00 |
| agent | polymerization: 10%) | | | | |
| | Isophorone diisocyanate (degree of | — | — | — | — |
| | polymerization: 50%) | | | | |
| | Isophorone diisocyanate (degree of | — | — | — | — |
| | polymerization: 95%) | | | | |
| | Trimethylolpropane acrylate (degree of | 1.00 | 1.00 | — | — |
| | polymerization: 10%) | | | | |
| | Unit of urethane structure and | — | — | — | — |
| | 6-functional resin | | | | |
| Polymerization | 2,4,6-Trimethylbenzoyl-diphenyl-phosphine | 1.00 | 1.00 | 1.00 | 1.00 |
| initiator | oxide | | | | |
| Total (% by mass) | | 100.00 | 100.00 | 100.00 | 100.00 |
| Ratio (S₃/S₃₀) | | 0.40 | 0.43 | 0.44 | 0.46 |
| G value | | 0.25 | 0.33 | 0.34 | 0.37 |
| Evaluation | Blocking resistance | C | C | B | B |
| criteria | Close adhesiveness | D | C | C | B |
| | Drawability | B | C | C | C |

[symbol]

indicates data missing or illegible when filed

TABLE 7-1

| | | Comparative Example | | |
|---|---|---|---|---|
| | | 1 | 2 | 3 |
| Active-energy- | Isobornyl acrylate | 57.00 | — | 11.00 |
| ray-curable | Phenoxyethyl acrylate | 42.00 | — | 8.00 |
| compound | 2-(2-Vinyloxyethoxy)ethyl acrylate | — | 54.00 | — |
| | Hydroxypivalic acid neopentylglycol acrylic | — | 40.00 | — |
| | acid adduct | | | |
| | Isooctyl acrylate | — | — | — |
| | Tetrahydrofurfuryl acrylate | — | — | — |
| Resin | Resin A1: epoxy resin (weight average | — | — | — |
| | molecular weight: 500, having unit of | | | |
| | benzene structure) | | | |
| | Resin A2: butadiene resin (weight average | — | 5.00 | 40.00 |
| | molecular weight: 1 × 10 [symbol] ) | | | |
| | Resin A3: acrylic resin (weight average | — | — | — |
| | molecular weight: 1 × 10⁴, | | | |
| | having unit of benzene structure) | | | |
| | Resin A4: ether resin (weight average | — | — | — |
| | molecular weight: 1 × 10⁷) | | | |
| | Resin B1: epoxy resin (weight average | — | — | 40.00 |
| | molecular weight: 500, having unit of | | | |
| | benzene structure) | | | |
| | Resin B2: acrylic resin (weight average | — | — | — |
| | molecular weight: 1 × 10 [symbol] ) | | | |
| | Resin B3: acrylic resin (weight average | — | — | — |
| | molecular weight: 1 × 10⁵) | | | |
| | Resin B4: ether resin (weight average | — | — | — |
| | molecular weight: 1 × 10⁷) | | | |
| | Resin C: styrene acrylic resin (weight average | — | — | — |
| | molecular weight: 1 × 10 [symbol] , | | | |
| | having unit of benzene structure) | | | |
| Cross-linking | Isophorone diisocyanate (degree of | — | — | — |
| agent | polymerization: 10%) | | | |
| | Isophorone diisocyanate (degree of | — | — | — |
| | polymerization: 50%) | | | |
| | Isophorone diisocyanate (degree of | — | — | — |
| | polymerization: 95%) | | | |
| | Trimethylolpropane acrylate (degree of | — | — | — |
| | polymerization: 10%) | | | |
| | Unit of urethane structure and | — | — | — |
| | 6-functional resin | | | |
| Polymerization | 2,4,6-Trimethylbenzoyl-diphenyl-phosphine | 1.00 | 1.00 | 1.00 |
| initiator | oxide | | | |
| Total (% by mass) | | 100.00 | 100.00 | 100.00 |
| Ratio (S₃/S₃₀) | | 0.18 | 0.15 | 0.87 |
| G value | | 0.03 | 0.02 | 0.78 |
| Evaluation | Blocking resistance | F | F | A |
| criteria | Close adhesiveness | F | F | A |
| | Drawability | A | A | F |

[symbol]

indicates data missing or illegible when filed

TABLE 7-2

| | | Comparative Example | | |
|---|---|---|---|---|
| | | 4 | 5 | 6 |
| Active-energy- | Isobornyl acrylate | 46.00 | — | 46.00 |
| ray-curable | Phenoxyethyl acrylate | — | 46.00 | 33.00 |
| compound | 2-(2-Vinyloxyethoxy)ethyl acrylate | — | — | — |
| | Hydroxypivalic acid neopentylglycol acrylic | — | — | — |
| | acid adduct | | | |
| | Isooctyl acrylate | — | 33.00 | — |
| | Tetrahydrofurfuryl acrylate | 33.00 | — | — |
| Resin | Resin A1: epoxy resin (weight average | 10.00 | — | — |
| | molecular weight: 500, having unit of | | | |
| | benzene structure) | | | |
| | Resin A2: butadiene resin (weight average | — | — | 2.00 |
| | molecular weight: 1 × 10 [symbol] ) | | | |
| | Resin A3: acrylic resin (weight average | — | — | — |
| | molecular weight: 1 × 10⁴, | | | |
| | having unit of benzene structure) | | | |
| | Resin A4: ether resin (weight average | — | 10.00 | — |
| | molecular weight: 1 × 10⁷) | | | |
| | Resin B1: epoxy resin (weight average | 10.00 | — | — |
| | molecular weight: 500, having unit of | | | |
| | benzene structure) | | | |
| | Resin B2: acrylic resin (weight average | — | — | — |
| | molecular weight: 1 × 10 [symbol] ) | | | |
| | Resin B3: acrylic resin (weight average | — | — | — |
| | molecular weight: 1 × 10 [symbol] ) | | | |
| | Resin B4: ether resin (weight average | — | 10.00 | — |
| | molecular weight: 1 × 10⁷) | | | |
| | Resin C: styrene acrylic resin (weight average | — | — | — |
| | molecular weight: 1 × 10 [symbol] , | | | |
| | having unit of benzene structure) | | | |
| Cross-linking | Isophorone diisocyanate (degree of | — | — | — |
| agent | polymerization: 10%) | | | |
| | Isophorone diisocyanate (degree of | — | — | — |
| | polymerization: 50%) | | | |
| | Isophorone diisocyanate (degree of | — | — | — |
| | polymerization: 95%) | | | |
| | Trimethylolpropane acrylate (degree of | — | — | — |
| | polymerization: 10%) | | | |
| | Unit of urethane structure and | — | — | 18.00 |
| | 6-functional resin | | | |
| Polymerization | 2,4,6-Trimethylbenzoyl-diphenyl-phosphine | 1.00 | 1.00 | 1.00 |
| initiator | oxide | | | |
| Total (% by mass) | | 100.00 | 100.00 | 100.00 |
| Ratio (S₃/S₃₀) | | 0.28 | 0.73 | 0.72 |
| G value | | 0.05 | 0.69 | 0.67 |
| Evaluation | Blocking resistance | F | A | A |
| criteria | Close adhesiveness | F | A | A |
| | Drawability | A | F | F |

[symbol]

indicates data missing or illegible when filed

In Tables 1-1 to 7-2, names of the products and the manufacturing companies are as follows.

<Active-Energy-Ray-Curable Compound>
Isobornyl acrylate (IBXA, available from Osaka Organic Chemical Industry Ltd.)
Phenoxyethyl acrylate (PEA, available from Osaka Organic Chemical Industry Ltd.)
2-(2-Vinyloxyethoxy)ethyl acrylate (VEEA, available from NIPPON SHOKUBAI CO., LTD.)
Hydroxypivalic acid neopentyl glycol acrylic acid adduct (HPPA, available from Kyoeisha Chemical Co., Ltd.)
Isooctyl acrylate (IOAA, available from Osaka Organic Chemical Industry Ltd.)
Tetrahydrofurfuryl acrylate (THFA, available from Osaka Organic Chemical Industry Ltd.)

<Resin>
Resin A1: epoxy resin (product name: 834 grade, available from Mitsubishi Chemical Corporation, weight average molecular weight: 500, semi-solid at normal temperature, having the benzene structure unit)
Resin A2: butadiene resin (product name: B-1000, available from Nippon Soda Co., Ltd., weight average molecular weight: 1×10³)
Resin A3: acrylic resin (product name: Aron A-12SL, available from Toagosei Company, Limited, weight average molecular weight: 1×10⁴, solid content concentration: from 39 by mass to 41% by mass, having the benzene structure unit)
Resin A4: ether resin (product name: PEO-4, available from Sumitomo Seika Chemicals Company Limited, weight average molecular weight: 1×10⁷, 5% by mass solution)
Resin B1: epoxy resin (product name: 828 grade, available from Mitsubishi Chemical Corporation, weight average molecular weight: 500, liquid at normal temperature, having the benzene structure unit)
Resin B2: acrylic resin (product name: VS-1202 grade, available from SEIKO PMC CORPORATION, weight average molecular weight: 1×10⁴)
Resin B3: acrylic resin (product name: 17913-500 code, available from Polysciences, weight average molecular weight: 1×10⁵)
Resin B4: ether resin (product name: PEO-3, available from Sumitomo Seika Chemicals Company Limited, weight average molecular weight: 1×10⁷, 5% by mass solution)
Resin C: styrene acrylic resin (product name: VS-1047, available from SEIKO PMC CORPORATION, weight average molecular weight: 1×10⁴, having the benzene structure unit)

Here, amounts of the resins described in the Tables are a value in terms of solid.

<Cross-Linking Agent>
Isophorone diisocyanate (IPDI, available from Mitsui Chemicals, Inc., degree of polymerization: 10%)
Isophorone diisocyanate (IPDI, available from Mitsui Chemicals, Inc., degree of polymerization: 50%)
Isophorone diisocyanate (IPDI, available from Mitsui Chemicals, Inc., degree of polymerization: 95%)
Trimethylolpropane acrylate (product name: NK Ester A-TMPT, available from Shin Nakamura Chemical Co., Ltd., degree of polymerization: 10%)

Here, amounts of the cross-linking agents described in the Tables are a value in terms of solid.

<Polymerization Initiator>
2,4,6-Trimethylbenzoyl-diphenyl-phosphine oxide (product name: LUCIRIN TPO, available from BASF)

—Evaluation as Recording Medium—

### Test Examples 1 and 2

A cured product was prepared by using the active-energy-ray-curable composition of Example 1 in the same manner as in Example 1 except that the kind of the recording medium was changed as described in the following Table 8. The cured product obtained was used to evaluate “blocking resistance”, “close adhesiveness”, and “drawability” in the same manner as in Example 1. Results are presented in Table 8.

TABLE 8

| | | | Test | Test |
|---|---|---|---|---|
| | | Example 1 | Example 1 | Example 2 |
| Active-energy-ray-curable | | Example 1 | Example 1 | Example 1 |
| composition | | | | |
| Recording medium | | Polycar- | Polyethylene | Polypro- |
| | | bonate | terephthalate | pylene |
| | | film | film | film |
| Ratio (S₃/S₃₀) | | 0.31 | 0.30 | 0.32 |
| G value | | 0.06 | 0.06 | 0.05 |
| Evaluation | Blocking resistance | E | E | E |
| criteria | Close adhesiveness | E | E | E |
| | Drawability | A | B | A |

Here, in the Table 8, names of the products and the manufacturing companies of the recording media are as described below.

<Recording Medium>
Polyethylene terephthalate film (product name: PET plate, standard size, available from plaport, average thickness: 3 mm)
Polypropylene film (product name: polypropylene sheet, available from OKAMOTO INDUSTRIES, INC., average thickness: 1 mm)

Aspects of the present disclosure are as follows, for example.
<1> An active-energy-ray-curable composition including
a resin,
wherein a ratio S₃/S₃₀ of the active-energy-ray-curable composition is 0.3 or more but 0.6 or less in a ¹H-NMR spectrum of the active-energy-ray-curable composition, the ¹H-NMR spectrum is obtained when a concentration of the active-energy-ray-curable composition in deuterated chloroform as a solvent is 3% by mass, the S₃₀ is an integrated value of all signals in the ¹H-NMR spectrum, and the S₃ is an integrated value of at least one broad signal in the ¹H-NMR spectrum.
<2> The active-energy-ray-curable composition according to <1>, wherein the ratio S₃/S₃₀ is 0.3 or more but 0.45 or less.
<3> The active-energy-ray-curable composition according to <1> or <2>, wherein a G value of the active-energy-ray-curable composition is 0.1 or more but 0.5 or less in a¹H-NMR spectrum of the active-energy-ray-curable composition, where the G value is obtained by Formula (1) below:

G value=S₃/(S₃₀+S₁₀)−S₁/(S₃₀+S₁₀) Formula (1),
the ¹H-NMR spectrum is obtained when the concentration of the active-energy-ray-curable composition is 1% by mass, the S₁₀ is an integrated value of all signals in the ¹H-NMR spectrum, and the S₁ is an integrated value of at least one broad signal in the ¹H-NMR spectrum.
<4> The active-energy-ray-curable composition according to any one of <1> to <3>, wherein the G value is 0.2 or more but 0.4 or less.
<5> The active-energy-ray-curable composition according to any one of <1> to <4>, further including an active-energy-ray-curable compound.
<6> The active-energy-ray-curable composition according to any one of <1> to <5>, wherein an amount of the active-energy-ray-curable compound is 25% by mass or more but 60% by mass or less.
<7> The active-energy-ray-curable composition according to any one of <1> to <6>, wherein the active-energy-ray-curable compound is at least one selected from isobornyl acrylate, phenoxyethyl acrylate, 2-(2-vinyloxyethoxy)ethyl acrylate, hydroxypivalic acid neopentyl glycol acrylic acid adduct, isooctyl acrylate, and tetrahydrofurfuryl acrylate.
<8> The active-energy-ray-curable composition according to any one of <1> to <7>, further including a cross-linking agent.
<9> The active-energy-ray-curable composition according to any one of <1> to <8>, wherein a degree of polymerization of the cross-linking agent is 10% or more but 95% or less.
<10> The active-energy-ray-curable composition according to any one of <1> to <9>, wherein an amount of the resin is 0.5% by mass or more but 30% by mass or less.
<11> The active-energy-ray-curable composition according to any one of <1> to <10>, wherein the resin is two or more kinds of resins.
<12> The active-energy-ray-curable composition according to <11>, wherein the active-energy-ray-curable composition includes the resin having a weight average molecular weight of 1×10³ or more but 1×10⁴ or less and the resin having a weight average molecular weight of more than 1×10⁴ but 1×10⁶ or less.
<13> The active-energy-ray-curable composition according to <11> or <12>, wherein at least one selected from the two or more kinds of resins has a benzene structure unit and an amount of the resin having the benzene structure unit is 25% by mass or more but 75% by mass or less relative to a total amount of the resins.
<14> An active-energy-ray-curable composition primer including the active-energy-ray-curable composition according to any one of <1> to <13>.
<15> A cured product, which is formed with at least one of the active-energy-ray-curable composition according to any one of <1> to <13> and the active-energy-ray-curable composition primer according to <14>.
<16> The cured product according to <15>, wherein the cured product is adhered to at least one recording medium selected from a polycarbonate film, a polyethylene terephthalate film, and a polypropylene film.
<17> A processed product, which is formed by drawing the cured product.
<18> A stored container including:
at least one of the active-energy-ray-curable composition according to any one of <1> to <13> and the active-energy-ray-curable composition primer according to <14>; and
a container including the at least one of the active-energy-ray-curable composition according to any one of <1> to <13> and the active-energy-ray-curable composition primer according to <14>.
<19> A two-dimensional or three-dimensional image forming apparatus including:
a storing part including at least one of the active-energy-ray-curable composition according to any one of <1> to <13> and the active-energy-ray-curable composition primer according to <14>; and
an irradiator configured to emit active energy rays.
<20> A two-dimensional or three-dimensional image forming method, the method including
irradiating at least one of the active-energy-ray-curable composition according to any one of <1> to <13> and the active-energy-ray-curable composition primer according to <14> with active energy rays to form a two-dimensional or three-dimensional image.

The active-energy-ray-curable composition according to any one of <1> to <13>, the active-energy-ray-curable composition primer according to <14>, the cured product according to <15> or <16>, the processed product according to <17>, the stored container according to <18>, the two-dimensional or three-dimensional image forming apparatus according to <19>, and the two-dimensional or three-dimensional image forming method according to <20> can solve the existing problems and can achieve the object of the present disclosure.

1. An active-energy-ray-curable composition comprising
a resin,
wherein a ratio S₃/S₃₀ of the active-energy-ray-curable composition is 0.3 or more but 0.6 or less in a ¹H-NMR spectrum of the active-energy-ray-curable composition, the ¹H-NMR spectrum is obtained when a concentration of the active-energy-ray-curable composition in deuterated chloroform as a solvent is 3% by mass, the S₃₀ is an integrated value of all signals in the ¹H-NMR spectrum, and the S₃ is an integrated value of at least one broad signal in the ¹H-NMR spectrum.

2. The active-energy-ray-curable composition according to claim 1,
wherein a G value of the active-energy-ray-curable composition is 0.1 or more but 0.5 or less in a ¹H-NMR spectrum of the active-energy-ray-curable composition, where the G value is obtained by Formula (1) below:
G value=S₃/(S₃₀+S₁₀)−S₁/(S₃₀+S₁₀) Formula (1),
the ¹H-NMR spectrum is obtained when the concentration of the active-energy-ray-curable composition is 1% by mass, the S₁₀ is an integrated value of all signals in the ¹H-NMR spectrum, and the S₁ is an integrated value of at least one broad signal in the ¹H-NMR spectrum.

3. The active-energy-ray-curable composition according to claim 1, further including an active-energy-ray-curable compound.

4. The active-energy-ray-curable composition according to claim 1, further including a cross-linking agent.

5. The active-energy-ray-curable composition according to claim 1, wherein an amount of the resin is 0.5% by mass or more but 30% by mass or less.

6. The active-energy-ray-curable composition according to claim 1, wherein the resin is two or more kinds of resins.

7. The active-energy-ray-curable composition according to claim 6, wherein the active-energy-ray-curable composition includes the resin having a weight average molecular weight of 1×10³ or more but 1×10⁴ or less and the resin having a weight average molecular weight of more than 1×10⁴ but 1×10⁶ or less.

8. The active-energy-ray-curable composition according to claim 6, wherein at least one selected from the two or more kinds of resins has a benzene structure unit and an amount of the resin having the benzene structure unit is 25% by mass or more but 75% by mass or less relative to a total amount of the resins.

9. An active-energy-ray-curable composition primer comprising
an active-energy-ray-curable composition,
wherein the active-energy-ray-curable composition includes a resin, and
wherein a ratio S₃/S₃₀ of the active-energy-ray-curable composition is 0.3 or more but 0.6 or less in a ¹H-NMR spectrum of the active-energy-ray-curable composition, the ¹H-NMR spectrum is obtained when a concentration of the active-energy-ray-curable composition in deuterated chloroform as a solvent is 3% by mass, the S₃₀ is an integrated value of all signals in the ¹H-NMR spectrum, and the S₃ is an integrated value of at least one broad signal in the ¹H-NMR spectrum.

10. A cured product, which is formed with the active energy ray curable composition according to claim 1.

11. A stored container comprising:
the active energy ray curable composition according to claim 1; and
a container including the active energy ray curable composition according to claim 1.

12. A two-dimensional or three-dimensional image forming apparatus comprising:
a storing part including an active energy ray curable composition; and
an irradiator configured to emit active energy rays,
wherein the active-energy-ray-curable composition includes a resin, and
wherein a ratio S₃/S₃₀ of the active-energy-ray-curable composition is 0.3 or more but 0.6 or less in a ¹H-NMR spectrum of the active-energy-ray-curable composition, the ¹H-NMR spectrum is obtained when a concentration of the active-energy-ray-curable composition in deuterated chloroform as a solvent is 3% by mass, the S₃₀ is an integrated value of all signals in the ¹H-NMR spectrum, and the S₃ is an integrated value of at least one broad signal in the ¹H-NMR spectrum.

13. A two-dimensional or three-dimensional image forming method, the method comprising
irradiating the active energy ray curable composition according to claim 1 with active energy rays to form a two-dimensional or three-dimensional image.
